(19) United States
(12) Patent Application Publication
(10) Pub. No.: US 2025/0249408 A1
(43) Pub. Date: Aug. 7, 2025

(54) Gas Separation Module

(71) Applicant: Hitachi-GE Nuclear Energy, Ltd., Hitachi-shi (JP)

(72) Inventors: Tomohisa SUZUKI, Tokyo (JP); Mina AMO, Tokyo (JP)

(21) Appl. No.: 19/041,201

(22) Filed: Jan. 30, 2025

(30) Foreign Application Priority Data
Feb. 7, 2024 (JP) 2024-017024

(51) Int. Cl. B01D 63/04; B01D 53/22

(52) U.S. Cl. CPC B01D 63/04; B01D 2053/224; B01D 2313/04; B01D 2313/201

(57) ABSTRACT

Provided is a gas separation module that can enhance durability under high-temperature water vapor of a fixing member that fixes a filter member to a housing. A gas separation module 1 includes a filter member 2 that separates a specific gas from a mixture gas, a housing 3 that has an inflow port 35 through which the mixture gas flows into and houses the filter member 2, and a fixing member 4 that fixes the filter member 2 to the housing 3 and seals a gap between the filter member 2 and the housing 3. At least a part of an inflow side surface 42 facing the inflow port 35 of the housing 3 of surfaces of the fixing member 4 is covered with a protective layer 6. The protective layer 6 is formed of an inorganic material having a characteristic of shielding water vapor and having a characteristic of being superior in heat resistance to the fixing member.

### TECHNICAL FIELD

The present invention relates to a gas separation module that separates a specific gas from a mixture gas containing two or more types of gases.

### BACKGROUND ART

Gas separation using a gas separation membrane is widely used in various fields such as petrochemistry, chemistry, precision machinery, food fields, automobiles, nuclear power, and environmental fields as a method that can be achieved by an energy saving and compact device, and its importance is increasing. Gas separation is performed by passing the mixture gas of a separation target through a gas separation module equipped with a gas separation membrane.

As the gas separation module, one in which a housing houses a filter in which a plurality of hollow fiber membranes are bundled is generally known (see, for example, PTL 1). In the hollow fiber membrane module described in PTL 1, a plurality of first hollow fiber membranes and a plurality of second hollow fiber membranes are bundled and filled in a case having a cylindrical shape. At both end portions of the case, the first hollow fiber membranes and the second hollow fiber membranes are fixed by a potting section such that only the hollow portions are opened. Both ends on a side surface side of the case are provided with a first opening portion and a second opening portion. The hollow fiber membrane module is used by being assembled to a housing having a pair of first pipe connection portions and a pair of second pipe connection portions. The pair of first pipe connection portions in the housing is a part serving as a flow channel leading to the hollow portions of the first hollow fiber membranes and the second hollow fiber membranes, and the pair of second pipe connection portions is a part serving as a flow channel leading to outer wall surface side of the first hollow fiber membranes and the second hollow fiber membranes through the first opening portion and the second opening portion of the case.

In the gas separation module having such a configuration, a first route that passes through the hollow portions of the first hollow fiber membranes and the second hollow fiber membranes from one first pipe connection portion and flows out to the other first pipe connection portion, and a second route that passes through the outer wall surface side of the first hollow fiber membranes and the second hollow fiber membranes from one second pipe connection portion via the first opening portion of the case and flows out to the other second pipe connection portion via the second opening portion of the case are formed. By causing a dehumidification target fluid (e.g., a wet gas such as water vapor or water) to flow to one of the first route and the second route and causing a humidification target fluid (e.g., dry gas) to flow to the other, moisture permeation is performed from one route to the other route by a membrane separation action by the first hollow fiber membranes and the second hollow fiber membranes.

Some gas separation modules are assumed to be used in an atmosphere of high-temperature water vapor. For example, PTL 2 discloses a manufacturing method of a hollow fiber membrane assumed to be used in a water vapor atmosphere at a high temperature condition of 80 to 140° C.

### CITATION LIST

### Patent Literature

PTL 1: JP 2004-209418 A
PTL 2: JP 2006-255502 A

### SUMMARY OF INVENTION

### Technical Problem

In the hollow fiber membrane module described in PTL 1, a potting section is formed by solidifying an adhesive such as epoxy (thermosetting resin) filled in both end portions of the case. When such a hollow fiber membrane module is used in an atmosphere of high-temperature water vapor as described in PTL 2, there is a concern that the potting section is deteriorated by high-temperature water vapor and the durability thereof is deteriorated.

The potting section functions as a fixing member that fixes a filter member such as a hollow fiber membrane to a case (housing). The fixing member (potting section) also has a function of sealing a gap between the filter member and the housing. When deterioration of the fixing member (potting section) progresses due to high-temperature water vapor, the filter member may be peeled off from the housing, or the fixing member may be cracked. In this case, the fixing function and the sealing function of the fixing member are impaired, so that the gas separation function of the gas separation module cannot be maintained.

The present invention has been made to solve the above problems, and an object of the present invention is to provide a gas separation module that can enhance durability under high-temperature water vapor of a fixing member that fixes a filter member to a housing.

### Solution to Problem

The present application includes a plurality of means for solving the above problem. A typical example of a gas separation module that is a solution of the present application includes: a filter member that separates a specific gas from a mixture gas; a housing that has an inflow port through which the mixture gas flows into and houses the filter member; and a fixing member that fixes the filter member to the housing and seals a gap between the filter member and the housing, in which at least a part of a first surface, which is a surface facing the inflow port side of the housing, of surfaces of the fixing member is covered with a protective layer, and the protective layer is formed of an inorganic material having a characteristic of shielding water vapor and having a characteristic of being superior in heat resistance to the fixing member.

### Advantageous Effects of Invention

According to an example of the solution of the present application, at least a part of a first surface present on an inflow side of a mixture gas in a fixing member is covered with a protective layer excellent in shielding property of water vapor and heat resistance, whereby it is possible to reduce a region of the first surface directly exposed to high-temperature water vapor at the time of gas separation of the mixture gas containing the high-temperature water vapor. Due to this, deterioration of the fixing member due to high-temperature water vapor is suppressed, and therefore durability of the fixing member under high-temperature water vapor can be enhanced.

Problems, configurations, and effects other than those described above will be made clear by the description of the following embodiments.

### BRIEF DESCRIPTION OF DRAWINGS

FIG. 1 is a cross-sectional view schematically illustrating a configuration and a structure of a gas separation module according to a first embodiment of the present invention.

FIG. 2 is a cross-sectional view of the gas separation module according to the first embodiment illustrated in FIG. 1 as viewed from the direction of arrows II-II.

FIG. 3 is a cross-sectional view schematically illustrating a configuration and a structure of a gas separation module according to a first modification of the first embodiment of the present invention.

FIG. 4 is a cross-sectional view of the gas separation module according to the first modification of the first embodiment as viewed from the direction of arrows IV-IV.

FIG. 5 is a cross-sectional view schematically illustrating a configuration and a structure of a gas separation module according to a second modification of the first embodiment of the present invention.

FIG. 6 is a cross-sectional view schematically illustrating a configuration and a structure of a gas separation module according to a third modification of the first embodiment of the present invention.

FIG. 7 is a cross-sectional view schematically illustrating a configuration and a structure of a gas separation module according to a second embodiment of the present invention.

### DESCRIPTION OF EMBODIMENTS

Embodiments of the gas separation module of the present invention will be described below with reference to the drawings. In the present embodiment, a configuration in which a mixture gas containing water vapor is supplied to the gas separation module to separate the water vapor from other gases will be described.

### First Embodiment

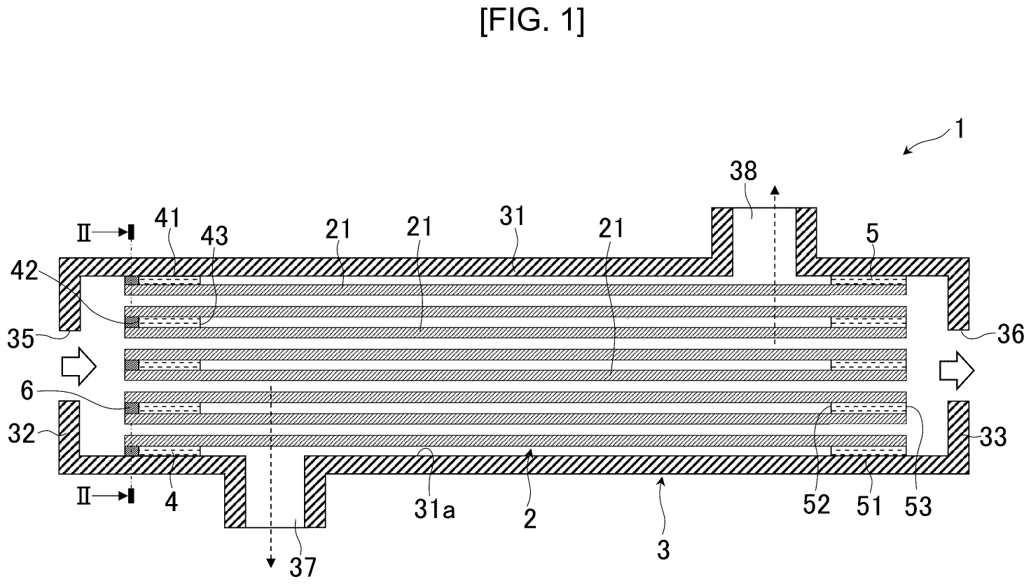

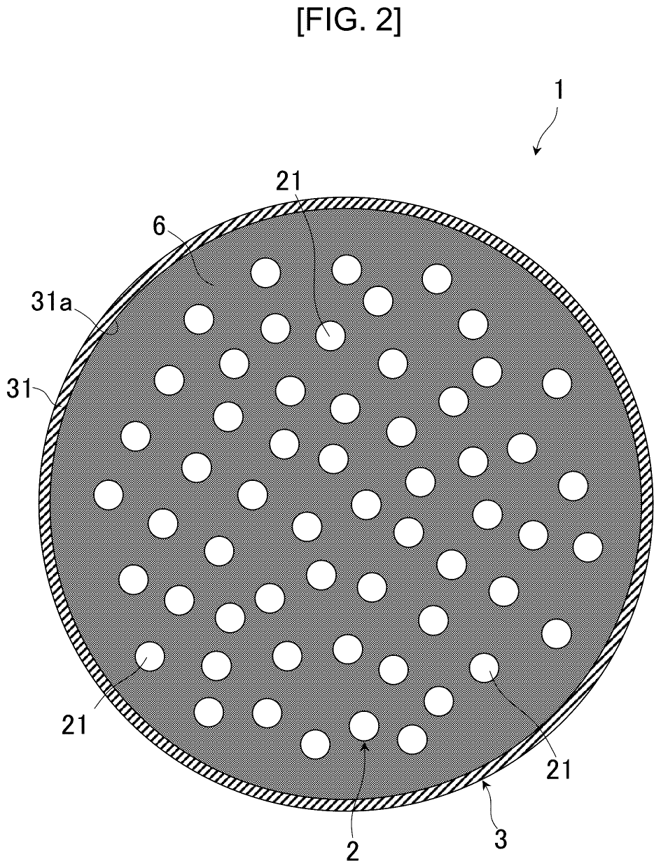

First, the configuration and the structure of the gas separation module according to the first embodiment of the present invention will be described with reference to FIGS. 1 and 2. FIG. 1 is a cross-sectional view schematically illustrating the configuration and the structure of the gas separation module according to the first embodiment. FIG. 2 is a cross-sectional view of the gas separation module according to the first embodiment illustrated in FIG. 1 as viewed from the direction of arrows II-II.

In FIG. 1, a gas separation module 1 is supplied with a mixture gas containing two or more types of gases, and separates a specific gas contained in the mixture gas from other gases. The mixture gas supplied to the gas separation module 1 is assumed to be a gas having a high temperature of about 120 to 200° C., and includes, for example, high-temperature water vapor in a range of 120 to 200° C. The gas separation module 1 includes, for example, a filter member 2 that separates a specific gas from a mixture gas, and a housing 3 that houses the filter member 2.

The housing 3 is, for example, a bottomed tubular container having heat resistance and pressure resistance. The housing 3 includes, for example, a tubular body portion 31 forming a housing space for housing the filter member 2, a first bottom portion 32 closing one side end portion (left end portion in FIG. 1) of the tubular body portion 31, and a second bottom portion 33 closing the other side end portion (right end portion in FIG. 1) of the tubular body portion 31.

The first bottom portion 32 is provided with an inflow port 35, and the second bottom portion 33 is provided with an outflow port 36. The inflow port 35 is a part through which the mixture gas flows in, and is positioned most upstream of the gas separation module 1. The outflow port 36 is a part through which a gas not permeating the filter member 2 of the mixture gas flows out.

A part of the tubular body portion 31 on the inflow port 35 (first bottom portion 32) side is provided with an upstream side opening portion 37. A part of the tubular body portion 31 on the outflow port 36 (second bottom portion 33) side is provided with a downstream side opening portion 38. The upstream side opening portion 37 and the downstream side opening portion 38 are configured as outflow ports for guiding, to the outside of the housing 3, the gas having permeated the filter member 2. Note that a configuration in which a large number of the upstream side opening portions 37 and a large number of the downstream side opening portions 38 are provided in the circumferential direction of the tubular body portion 31 is possible. A configuration in which only one of the upstream side opening portion 37 and the downstream side opening portion 38 is provided in the tubular body portion 31 is possible.

The filter member 2 has a characteristic (hereinafter, called selective permeability) of selectively transmitting a specific gas from a mixture gas and not transmitting a gas having a molecular size (dynamic molecular diameter) larger than that of the specific gas. The filter member 2 has a characteristic of, for example, selectively transmitting water vapor and hydrogen gas, and not transmitting gas having a molecular size (dynamic molecular diameter) larger than that of water vapor and hydrogen gas. Examples of the filter member 2 include a polymer membrane formed of a material containing polyimide as a main component. Note that the filter member 2 is not limited to the polymer membrane, and may be any membrane having the above characteristic.

The filter member 2 is configured by bundling a large number of membranes 21 having a hollow fiber shape (hereinafter, called a hollow fiber membrane), for example. The filter member 2 is configured such that the large number of bundled hollow fiber membranes 21 extend in the axial direction (left-right direction in FIG. 1) of the tubular body portion 31 of the housing 3. The filter member 2 is fixed to the housing 3 by joining an end portion (end portion on the inflow port 35 side) on one side (left side in FIG. 1) and an end portion (end portion on the outflow port 36 side) on the other side (right side in FIG. 1) in the extending direction of the large number of bundled hollow fiber membranes 21 to the tubular body portion 31 by an upstream side fixing member 4 and a downstream side fixing member 5, respectively.

The upstream side fixing member 4 and the downstream side fixing member 5 are formed of resin such as thermosetting resin as a main component. Examples of the material of the upstream side fixing member 4 and the downstream side fixing member 5 include, but are not limited to, epoxy resin, unsaturated polyester resin, urethane resin, urea resin, phenol resin, melamine resin, and silicone resin. Note that the epoxy resin has a glass transition temperature of 100 to 120° C. For this reason, a member formed of the epoxy resin is often used in a temperature range equal to or lower than that.

The upstream side fixing member 4 and the downstream side fixing member 5 are formed, for example, by filling and solidifying the above-described resin in the gap between the large number of hollow fiber membranes 21 and the tubular body portion 31. Due to this, by being joined to an inner peripheral surface 31a of the housing 3 (tubular body portion 31) at joint interfaces 41 and 51 that are the outer peripheral surfaces of the upstream side fixing member 4 and the downstream side fixing member 5, the upstream side fixing member 4 and the downstream side fixing member 5 fix (fixing function) the filter member 2 configured by the large number of hollow fiber membranes 21 to the housing 3, and seal (sealing function) a gap between both side end portions of the filter member 2 and the tubular body portion 31 in a state where hollow portions of the large number of hollow fiber membranes 21 are communicated without being closed.

The upstream side fixing member 4 has, as surfaces of the upstream side fixing member 4, an inflow side surface 42 as a first surface, which is a surface facing the inflow port 35 side (first bottom portion 32 side) of the housing 3, and an outflow side surface 43 as a second surface, which is a surface positioned on the opposite side of the inflow side surface 42 and facing the outflow port 36 side (second bottom portion 33 side) of the housing 3. The downstream side fixing member 5 has, as surfaces of the downstream side fixing member 5, an inflow side surface 52 as a third surface, which is a surface facing the inflow port 35 side (first bottom portion 32 side) of the housing 3, and an outflow side surface 53 as a fourth surface, which is a surface positioned on the opposite side of the inflow side surface 52 and facing the outflow port 36 side (second bottom portion 33 side) of the housing 3.

Of the surfaces of the upstream side fixing member 4, the inflow side surface 42 positioned on the inflow port 35 side is covered with a protective layer 6. As illustrated in FIGS. 1 and 2, the protective layer 6 covers the entire surface of the inflow side surface 42. The protective layer 6 is made of an inorganic material having a characteristic of shielding water vapor and superior in heat resistance to the upstream side fixing member 4 and the downstream side fixing member 5. Examples of the inorganic material forming the protective layer 6 include metal, metal oxides, ceramics, and glass. In particular, in a case where the protective layer 6 having such a configuration in which a low-melting-point glass having a softening point of 300° C. or higher and 360° C. or lower is preferably formed as a main material is used as the protective layer 6, the temperature when the protective layer 6 is molded can be suppressed to be low, and therefore a thermal influence on the upstream side fixing member 4 and the housing 3 in contact with the protective layer 6 can be reduced. As a formation method of the protective layer 6, there is a method of forming the protective layer 6 by forming a layer having a predetermined thickness on the entire surface of the inflow side surface 42 of the upstream side fixing member 4, for example, and then cutting out an end surface portion of the layer so that the hollow fiber membrane 21 is opened.

The thermal expansion coefficients among the three members of the upstream side fixing member 4, the housing 3, and the protective layer 6 are preferably as close as possible to one another. This is for suppressing peeling off of the upstream side fixing member 4 and the housing 3 and peeling off of the upstream side fixing member 4 and the protective layer 6 due to a thermal expansion coefficient difference among the three members 3, 4, and 6. The thermal expansion coefficient among the three members of the upstream side fixing member 4, the housing 3, and the protective layer 6 is preferably the relationship of the following expression (1), for example.

$$α 1 \leq α 2 \leq α3 \qquad ( 1 )$$

Here, α1, α2, and α3 are the thermal expansion coefficient of the protective layer 6, the thermal expansion coefficient of the upstream side fixing member 4, and the thermal expansion coefficient of the housing 3, respectively.

In order to lower the thermal expansion coefficient α2 of the upstream side fixing member 4, the upstream side fixing member 4 can be configured to contain additives such as fillers and fibers made of inorganic materials. Examples of the additive to the main material (resin) of the upstream side fixing member 4 include metal, metal oxides, glass, and carbon materials. By bringing the thermal expansion coefficient of the upstream side fixing member 4 in contact with both the protective layer 6 and the housing 3 close to the thermal expansion coefficients of both the protective layer 6 and the housing 3, it is possible to avoid peeling off of the members 3, 4, and 6 from one another even if they thermally expand.

Note that in the present embodiment, the outflow side surface 43 of the surfaces of the upstream side fixing member 4 is not covered with the protective layer and is exposed in the housing 3. Both surfaces of the downstream side fixing member 5, that is, the inflow side surface 52 and the outflow side surface 53 are not covered with the protective layer and are exposed in the housing 3.

In the gas separation module 1 configured as described above, the gap between both side end portions of the filter member 2 and the tubular body portion 31 is sealed by the upstream side fixing member 4 and the downstream side fixing member 5, whereby the flow channel through which the mixture gas flows and the flow channel through which the gas having permeated the filter member 2 (hollow (fiber membrane 21) flows are completely separated. That is, in the gas separation module 1, the mixture gas is prevented from flowing outside the hollow fiber membranes 21 of the filter member 2 and flows only in the hollow portions of the hollow fiber membranes 21, and a specific gas permeates from the inside to the outside of the hollow fiber membrane 21, and thus the gas separation module 1 performs gas separation.

Next, actions and effects of the gas separation module according to the first embodiment will be described with reference to FIG. 1. Here, a case where a mixture gas containing high-temperature and high-pressure water vapor is supplied will be described as an example.

The mixture gas containing high-temperature and high-pressure water vapor is supplied into the housing 3 via the inflow port 35 of the gas separation module 1 (see white arrow). First, the mixture gas flowing into the housing 3 is introduced from the opening on the upstream side (left side in FIG. 1) of the hollow portions in the large number of hollow fiber membranes 21 constituting the filter member 2 and passes therethrough. At this time, water vapor and hydrogen gas selectively permeate from the hollow portions of hollow fiber membranes 21 to the outside of the membrane, and flow out to the outside of housing 3 via the upstream side opening portion 37 and the downstream side opening portion 38 (see broken line arrow). However, the entire amounts of the water vapor and the hydrogen gas contained in the mixture gas do not permeate the filter member 2. The permeation amount varies depending on various conditions such as the fluid velocity and the fluid pressure of the fluid flowing through hollow fiber membranes 21 and the diameter of hollow fiber membrane 21. On the other hand, of the mixture gas, water vapor and hydrogen gas having not been permeated the filter member 2, and a gas having a molecular size (dynamic molecular diameter) larger than that of the water vapor and hydrogen gas pass through the hollow portions of the hollow fiber membranes 21, and then flow out to the outside of the housing 3 via the outflow port 36 of the housing 3 (see white arrow).

In the present embodiment, the entire surface of the inflow side surface 42 in the upstream side fixing member 4 positioned in the region where the mixture gas containing high-temperature and high-pressure water vapor flows into the housing 3 is covered with the protective layer 6 having excellent shielding property of water vapor and heat resistance. Due to this, the entirety of the inflow side surface 42 of the upstream side fixing member 4 can be avoided from being directly exposed to high-temperature and high-pressure water vapor, and therefore deterioration due to high-temperature water vapor of the upstream side fixing member 4 mainly formed of a resin material is suppressed, and durability of the upstream side fixing member 4 under high-temperature water vapor can be enhanced. Hence, the fixing function of the upstream side fixing member 4 for fixing the filter member 2 to the tubular body portion 31 and the sealing function of the upstream side fixing member 4 for sealing the gap between the filter member 2 and the tubular body portion 31 can be prevented from being damaged by deterioration of the upstream side fixing member 4, and therefore the gas separation performance of the gas separation module 1 under a severe environment can be maintained.

The gas separation module 1 according to the first embodiment described above includes the filter member 2 that separates a specific gas from a mixture gas, the housing 3 that has the inflow port 35 through which the mixture gas flows into and houses the filter member 2, and the fixing member (the upstream side fixing member 4 and the downstream side fixing member 5) that fixes the filter member 2 to the housing 3 and seals a gap between the filter member 2 and the housing 3. At least a part of the inflow side surface 42 (first surface), which is a surface facing the inflow port 35 side of the housing 3, of the surfaces of the upstream side fixing member 4 (fixing member) is covered with the protective layer 6. The protective layer 6 is made of an inorganic material having a characteristic of shielding water vapor and a characteristic superior in heat resistance to that of the upstream side fixing member 4 and the downstream side fixing member 5 (fixing member).

According to this configuration, at least a part of the inflow side surface 42 (first surface) present on the inflow side of the mixture gas in the upstream side fixing member 4 (fixing member) is covered with the protective layer 6 excellent in shielding property of water vapor and heat resistance, whereby it is possible to reduce the region of the inflow side surface 42 (first surface) directly exposed to high-temperature water vapor at the time of gas separation of the mixture gas containing the high-temperature water vapor. Due to this, deterioration of the upstream side fixing member 4 (fixing member) due to high-temperature water vapor is suppressed, and therefore durability of the upstream side fixing member 4 (fixing member) under high-temperature water vapor can be enhanced.

The protective layer 6 according to the present embodiment is made of glass having a softening point of 300° C. or higher and 360° C. or lower.

According to this configuration, since the temperature at the time of molding the protective layer 6 can be suppressed to be low, the thermal influence on the upstream side fixing member 4 (fixing member) in contact with the protective layer 6 at the time of molding and the housing 3 positioned in the vicinity of the protective layer 6 can be reduced.

In the present embodiment, the thermal expansion coefficient of the upstream side fixing member 4 (fixing member) is a value between the thermal expansion coefficient of the housing 3 and the thermal expansion coefficient of the protective layer 6, or the same value as the thermal expansion coefficient of any one of the housing 3 and the protective layer 6.

According to this configuration, by bringing the thermal expansion coefficient of the upstream side fixing member 4 (fixing member) in contact with both members of the housing 3 and the protective layer 6 close to the thermal expansion coefficients of the housing 3 and the protective layer 6, it is possible to simultaneously suppress peeling off between the housing 3 and the upstream side fixing member 4 (fixing member) and peeling off between the protective layer 6 and the upstream side fixing member 4 (fixing member) due to a thermal expansion coefficient difference among the three members 3, 4, and 6.

In the present embodiment, the protective layer 6 covers the entire surface of the inflow side surface 42 (first surface) of the upstream side fixing member 4 (fixing member).

According to this configuration, it is possible to avoid direct exposure to high-temperature water vapor over the entire surface of the inflow side surface 42 (first surface) of the upstream side fixing member 4 (fixing member), and therefore it is possible to reliably suppress deterioration of the upstream side fixing member 4 (fixing member) due to the high-temperature water vapor. This can further enhance durability of the upstream side fixing member 4 (fixing member) under high-temperature water vapor.

### First Modification of First Embodiment

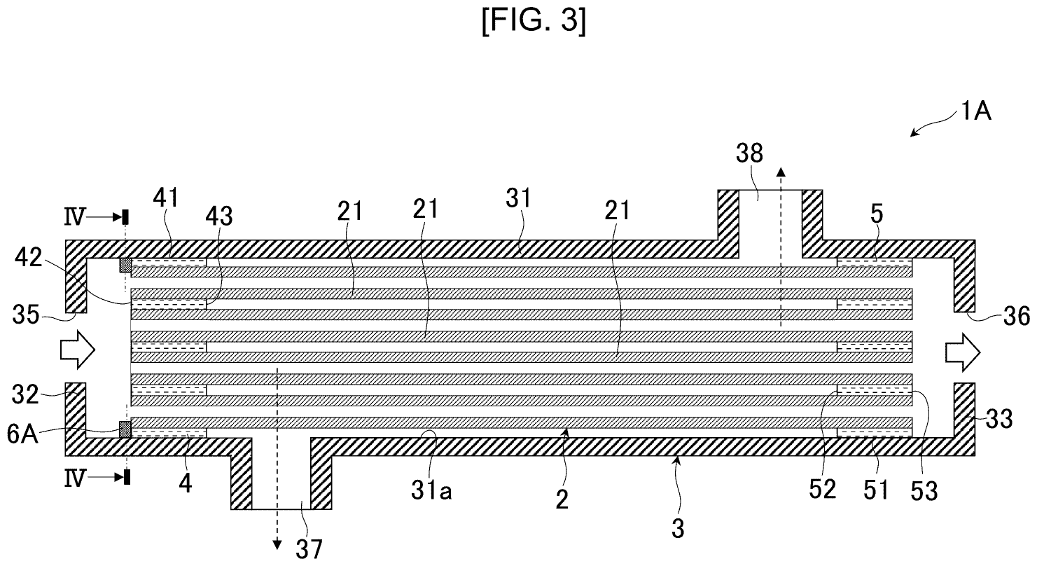

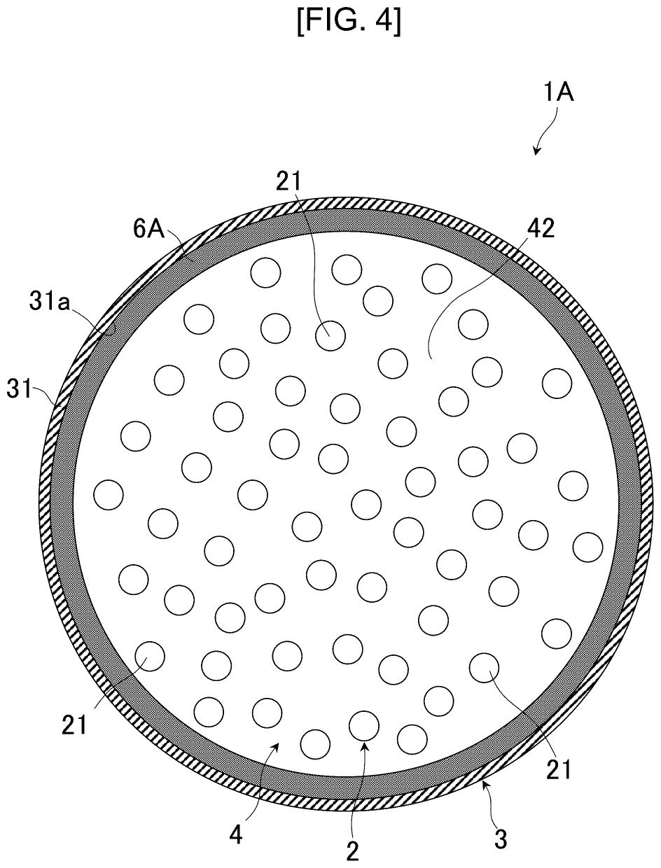

Next, the gas separation module according to the first modification of the first embodiment of the present invention will be described with reference to FIGS. 3 and 4. FIG. 3 is a cross-sectional view schematically illustrating the configuration and the structure of the gas separation module according to the first modification of the first embodiment. FIG. 4 is a cross-sectional view of the gas separation module according to the first modification of the first embodiment as viewed from the direction of arrows IV-IV. Note that in FIGS. 3 and 4, those having the same reference signs as those illustrated in FIGS. 1 to 2 are similar parts, and therefore detailed description thereof will be omitted.

A gas separation module 1A according to the first modification of the first embodiment illustrated in FIGS. 3 and 4 is different from the gas separation module 1 (see FIG. 1) according to the first embodiment in that a covered range of a protective layer 6A is limited to not the entire surface but a part of the inflow side surface 42 of the upstream side fixing member 4. The other configurations of the first modification of the first embodiment are similar to the configurations of the first embodiment, and the description thereof will be omitted.

Specifically, as illustrated in FIGS. 3 and 4, the protective layer 6A covers only an annular outer peripheral edge portion that is a region continuous to the joint interface 41 of the upstream side fixing member 4 joined to the inner peripheral surface 31a of the housing 3 (tubular body portion 31) of the inflow side surface 42 of the upstream side fixing member 4. That is, the protective layer 6A is annularly formed along the outer peripheral edge portion in the inflow side surface 42 of the upstream side fixing member 4.

Thus, in the first modification, the annular outer peripheral edge portion of the inflow side surface 42 of the upstream side fixing member 4 is covered with the protective layer 6A. This can avoid the annular outer peripheral edge portion of the inflow side surface 42 continuous to the joint interface 41 of the upstream side fixing member 4 from being directly exposed to high-temperature and high-pressure water vapor. For this reason, the deterioration form due to the high-temperature water vapor of the upstream side fixing member 4 in which the joint interface 41 of the upstream side fixing member 4 is peeled off from the inner peripheral surface 31a of the housing 3 is suppressed, and therefore durability of the upstream side fixing member 4 under the high-temperature water vapor can be enhanced. This can maintain the gas separation performance of the gas separation module 1A under a severe environment.

In the first modification, the covered range of the protective layer 6A is limited to not the entirety of the inflow side surface 42 of the upstream side fixing member 4 but the outer peripheral edge portion of the inflow side surface 42. Therefore, the use amount of the material to form the protective layer 6A can be reduced as compared with that of the protective layer 6 of the first embodiment.

In the first modification, the protective layer 6A may be formed only on the outer peripheral edge portion of the inflow side surface 42 of the upstream side fixing member 4. Therefore, in the formation process of the protective layer 6A, a cut out process of the end surface portion of the protective layer for securing the opening of the hollow fiber membrane 21 as in the formation process of the protective layer 6 of the first exemplary embodiment is unnecessary. Therefore, the formation process of the protective layer 6A is simplified.

According to the first modification of the first embodiment described above, similarly to the first embodiment, at least a part of the inflow side surface 42 (first surface) of the upstream side fixing member 4 (fixing member) is covered with the protective layer 6A, whereby it is possible to reduce the region of the inflow side surface 42 (first surface) directly exposed to high-temperature water vapor. Due to this, deterioration of the upstream side fixing member 4 (fixing member) due to high-temperature water vapor is suppressed, and therefore durability of the upstream side fixing member 4 (fixing member) under high-temperature water vapor can be enhanced.

In the gas separation module 1A according to the first modification, the protective layer 6A covers an annular outer peripheral edge portion that is a region continuous to the joint interface 41 of the upstream side fixing member 4 (fixing member) joined to the housing 3 of the inflow side surface 42 (first surface) of the upstream side fixing member 4 (fixing member).

According to this configuration, the protective layer 6A can avoid the outer peripheral edge portion of the inflow side surface 42 (first surface) continuous to the joint interface 41 from being directly exposed to high-temperature and high-pressure water vapor. Therefore, it is possible to suppress deterioration of the upstream side fixing member 4 (fixing member) such that the joint interface 41 of the upstream side fixing member 4 (fixing member) peels off from the housing 3.

### Second Modification of First Embodiment

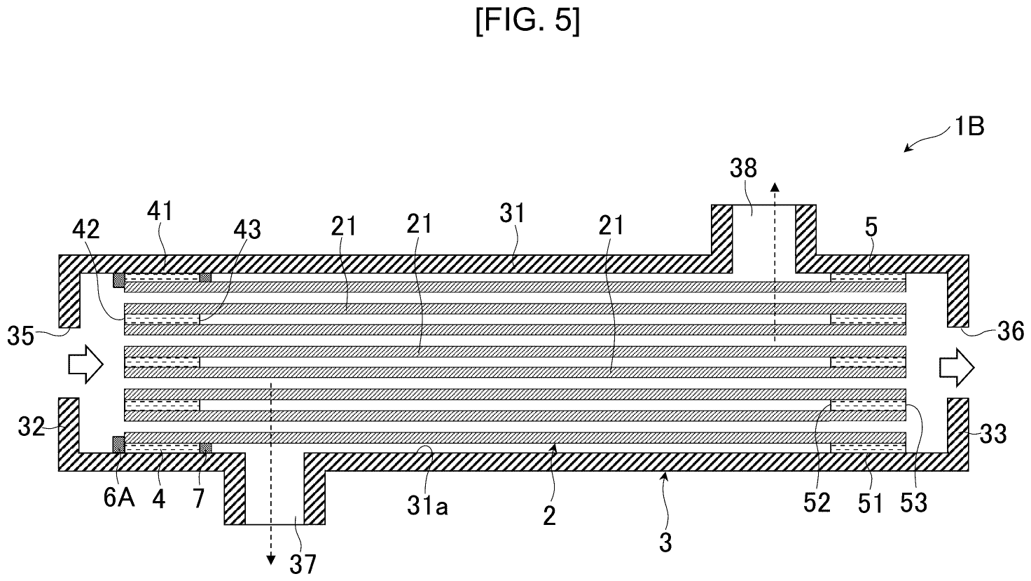

Next, the gas separation module according to the second modification of the first embodiment will be described with reference to FIG. 5. FIG. 5 is a cross-sectional view schematically illustrating the configuration and the structure of the gas separation module according to the second modification of the first embodiment. Note that in FIG. 5, those having the same reference signs as those illustrated in FIGS. 1 to 4 are similar parts, and therefore detailed description thereof will be omitted.

A gas separation module 1B according to the second modification of the first embodiment illustrated in FIG. 5 is different from the gas separation module 1A (see FIG. 3) according to the first modification in that a part of the outflow side surface 43 of the upstream side fixing member 4 is covered with a protective layer 7, in addition to that the inflow side surface 42 of the upstream side fixing member 4 is covered with the protective layer 6A. The other configurations of the second modification of the first embodiment t are similar to the configurations of the first embodiment, and the description thereof will be omitted.

Specifically, similarly to the first modification, the protective layer 6A covers the annular outer peripheral edge portion that is a region continuous to the joint interface 41 of the upstream side fixing member 4 joined to the housing 3 (tubular body portion 31) of the inflow side surface 42 of the upstream side fixing member 4. That is, the protective layer 6A is annularly formed along the outer peripheral edge portion in the inflow side surface 42 of the upstream side fixing member 4.

Furthermore, unlike the first modification, the protective layer 7 covers an annular outer peripheral edge portion that is a region continuous to the joint interface 41 of the upstream side fixing member 4 joined to the housing 3 (tubular body portion 31) of the outflow side surface 43 of the upstream side fixing member 4. That is, the protective layer 7 is annularly formed along the outer peripheral edge portion in the outflow side surface 43 of the upstream side fixing member 4. The protective layer 7 has a characteristic similar to that of the protective layer 6A. That is, the protective layer 7 is formed of an inorganic material having a characteristic of shielding water vapor and having heat resistance higher than that of the upstream side fixing member 4 and the downstream side fixing member 5.

Thus, in the second modification, a part of the outflow side surface 43 of the upstream side fixing member 4 is covered with the protective layer 7 excellent in shielding property of water vapor and heat resistance. The outflow side surface 43 is a surface of the upstream side fixing member 4 facing a region side where high-temperature and high-pressure water vapor flows when the high-temperature and high-pressure water vapor and hydrogen gas selectively permeate from the hollow portion of the hollow fiber membrane 21 to the outside of the membrane and flow out to the outside of the housing 3 via the upstream side opening portion 37 (see broken line arrow). Therefore, the region directly exposed to high-temperature and high-pressure water vapor can be reduced also with respect to the outflow side surface 43, which is the back side of the inflow side surface 42 of the upstream side fixing member 4. Due to this, deterioration of the upstream side fixing member 4 due to high-temperature water vapor is suppressed, and therefore durability of the upstream side fixing member 4 under high-temperature water vapor can be enhanced.

In the second modification, the annular outer peripheral edge portion of the outflow side surface 43 of the upstream side fixing member 4 is covered with the protective layer 7. This can avoid the annular outer peripheral edge portion of the outflow side surface 43 continuous to the joint interface 41 of the upstream side fixing member 4 from being directly exposed to high-temperature and high-pressure water vapor. For this reason, the deterioration form due to the high-temperature water vapor of the upstream side fixing member 4 in which the joint interface 41 of the upstream side fixing member 4 is peeled off from the housing 3 is suppressed, and therefore durability of the upstream side fixing member 4 under the high-temperature water vapor can be enhanced. This can maintain the gas separation performance of the gas separation module 1B under a severe environment.

According to the second modification of the first embodiment described above, similarly to the first modification, at least a part of the inflow side surface 42 (first surface) of the upstream side fixing member 4 (fixing member) is covered with the protective layer 6A, whereby it is possible to reduce the region of the inflow side surface 42 (first surface) directly exposed to high-temperature water vapor. Due to this, deterioration of the upstream side fixing member 4 (fixing member) due to high-temperature water vapor is suppressed, and therefore durability of the upstream side fixing member 4 (fixing member) under high-temperature water vapor can be enhanced.

In the gas separation module 1B according to the second modification, the protective layer 7 covers at least a part of the outflow side surface 43 (second surface), which is a surface positioned on the opposite side of the inflow side surface 42 (first surface), of the surfaces of the upstream side fixing member 4 (fixing member).

According to this configuration, at least a part of the outflow side surface 43 (second surface) is covered with the protective layer 7, whereby it is possible to further reduce the region of the upstream side fixing member 4 (fixing member) directly exposed to high-temperature water vapor. Due to this, deterioration of the upstream side fixing member 4 (fixing member) due to high-temperature vapor is further suppressed, and therefore durability of the upstream side fixing member 4 (fixing member) under high-temperature water vapor can be further enhanced.

In the gas separation module 1B according to the second modification, the protective layer 7 covers an annular outer peripheral edge portion that is a region continuous to the joint interface 41 of the upstream side fixing member 4 (fixing member) joined to the housing 3 of the outflow side surface 43 (second surface).

According to this configuration, the protective layer 7 can avoid the outer peripheral edge portion of the outflow side surface 43 (second surface) continuous to the joint interface 41 from being directly exposed to high-temperature and high-pressure water vapor. Therefore, it is possible to suppress deterioration of the upstream side fixing member 4 (fixing member) such that the joint interface 41 of the upstream side fixing member 4 (fixing member) peels off from the housing 3.

### Third Modification of First Embodiment

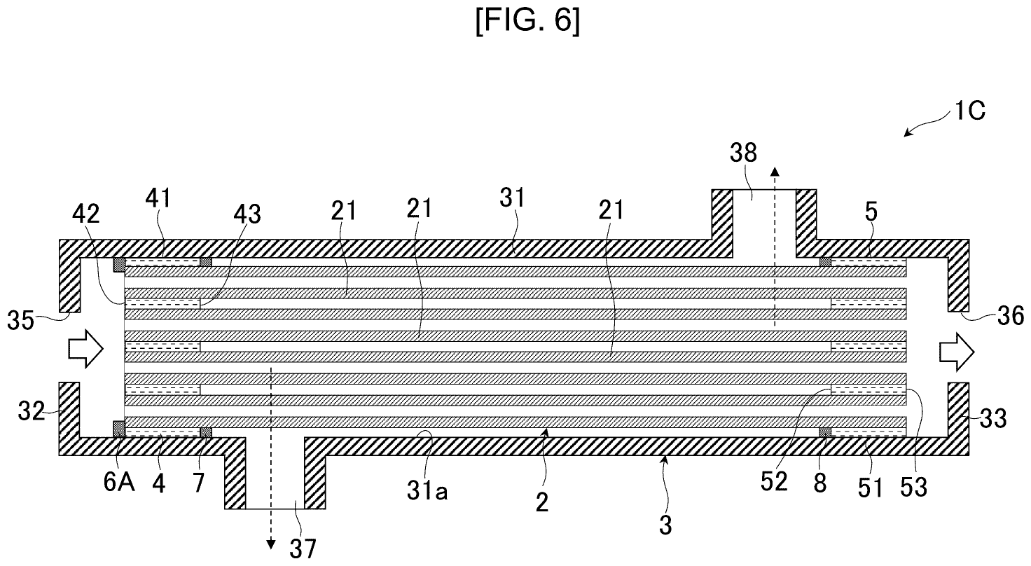

Next, the gas separation module according to the third modification of the first embodiment will be described with reference to FIG. 6. FIG. 6 is a cross-sectional view schematically illustrating the configuration and the structure of the gas separation module according to the third modification of the first embodiment. Note that in FIG. 6, those having the same reference signs as those illustrated in FIGS. 1 to 5 are similar parts, and therefore detailed description thereof will be omitted.

A gas separation module 1C according to the third modification of the first embodiment illustrated in FIG. 6 is different from the gas separation module 1B (see FIG. 5) according to the second modification in that the inflow side surface 52 of the downstream side fixing member 5 is covered with a protective layer 8 in addition to that the inflow side surface 42 and the outflow side surface 43 of the upstream side fixing member 4 are covered with the protective layer 6A and the protective layer 7, respectively. The other configurations of the third modification of the first embodiment are similar to the configurations of the second modification, and the description thereof will be omitted.

Specifically, similarly to the second modification, the protective layer 6A covers the annular outer peripheral edge portion continuous to the joint interface 41 of the upstream side fixing member 4 joined to the housing 3 of the inflow side surface 42 of the upstream side fixing member 4. The protective layer 7 covers the annular outer peripheral edge portion continuous to the joint interface 41 of the upstream side fixing member 4 joined to the housing 3 of the outflow side surface 43 of the upstream side fixing member 4.

Furthermore, unlike the second modification, the protective layer 8 covers a part of the inflow side surface 52 of the downstream side fixing member 5. Specifically, the protective layer 8 covers the annular outer peripheral edge portion continuous to the joint interface 51 of the downstream side fixing member 5 joined to the housing 3 of the inflow side surface 52 of the downstream side fixing member 5. That is, the protective layer 8 is annularly formed along the outer peripheral edge portion in the inflow side surface 52 of the downstream side fixing member 5. The protective layer 8 has a characteristic similar to those of the protective layer 6A and the protective layer 7. That is, the protective layer 8 is formed of an inorganic material having a characteristic of shielding water vapor and having heat resistance higher than that of the upstream side fixing member 4 and the downstream side fixing member 5.

Thus, in the third modification, a part of the inflow side surface 52 of the downstream side fixing member 5 is covered with the protective layer 8 excellent in shielding property of water vapor and heat resistance. The inflow side surface 52 of the downstream side fixing member 5 is a surface of the downstream side fixing member 5 facing a region side where high-temperature and high-pressure water vapor flows when the high-temperature and high-pressure water vapor and hydrogen gas selectively permeate from the hollow portion of the hollow fiber membrane 21 to the outside of the membrane and flow out to the outside of the housing 3 via the downstream side opening portion 38 (see broken line arrow). Therefore, the region directly exposed to high-temperature and high-pressure water vapor can be reduced also with respect to the inflow side surface 52 of the downstream side fixing member 5. Due to this, deterioration of the downstream side fixing member 5 due to high-temperature water vapor is suppressed, and therefore durability of the downstream side fixing member 5 under high-temperature water vapor can be enhanced.

In the third modification, the annular outer peripheral edge portion of the inflow side surface 52 of the downstream side fixing member 5 is covered with the protective layer 8. This can avoid the annular outer peripheral edge portion of the inflow side surface 52 continuous to the joint interface 51 of the downstream side fixing member 5 from being directly exposed to high-temperature and high-pressure water vapor. For this reason, the deterioration form due to the high-temperature water vapor of the downstream side fixing member 5 in which the joint interface 51 of the downstream side fixing member 5 is peeled off from the housing 3 is suppressed, and therefore durability of the downstream side fixing member 5 under the high-temperature water vapor can be enhanced. This can maintain the gas separation performance of the gas separation module 1C under a severe environment.

According to the third modification of the first embodiment described above, similarly to the second modification, at least a part of the inflow side surface 42 (first surface) of the upstream side fixing member 4 (fixing member) is covered with the protective layer 6A, whereby it is possible to reduce the region of the inflow side surface 42 (first surface) directly exposed to high-temperature water vapor. Due to this, deterioration of the upstream side fixing member 4 (fixing member) due to high-temperature water vapor is suppressed, and therefore durability of the upstream side fixing member 4 (fixing member) under high-temperature water vapor can be enhanced.

In the gas separation module 1C according to the third modification, the filter member 2 is configured to bundle the plurality of hollow fiber membranes 21, and an end portion on one side and an end portion on the other side in the extending direction of the plurality of hollow fiber membranes 21 are fixed to the housing 3 by fixing members (the upstream side fixing member 4 and the downstream side fixing member 5), respectively. The housing 3 includes the inflow port 35 on one side in the extending direction of the plurality of hollow fiber membranes 21. The fixing member includes the upstream side fixing member 4 (first fixing member) that fixes one end portion of the plurality of hollow fiber membranes 21 to the housing 3, and the downstream side fixing member 5 (second fixing member) that fixes the other end portion of the plurality of hollow fiber membranes 21 to the housing 3. At least a part of the inflow side surface 42 (first surface), which is a surface facing the inflow port 35 of the housing 3, of the surfaces of the upstream side fixing member 4 (first fixing member) is covered with the protective layer 6A, and at least a part of the inflow side surface 52 (third surface), which is a surface facing the inflow port 35 of the housing 3, of the surfaces of the downstream side fixing member 5 (second fixing member) is covered with the protective layer 8.

According to this configuration, at least a part of the inflow side surface 42 (first surface) of the upstream side fixing member 4 (first fixing member) and at least a part of the inflow side surface 52 (third surface) of the downstream side fixing member 5 (second fixing member) are covered with the protective layer 6A and the protective layer 8, whereby the regions of the surfaces of both the fixing members 4 and 5 that are directly exposed to high-temperature water vapor can be reduced. Due to this, deterioration of both the fixing members 4 and 5 due to high-temperature water vapor is suppressed, and therefore durability of both the fixing members 4 and 5 under high-temperature water vapor can be enhanced.

In the gas separation module 1C according to the third modification, the protective layer 8 covers an annular outer peripheral edge portion that is a region continuous to the joint interface 51 of the downstream side fixing member 5 (second fixing member) joined to the housing 3 of the inflow side surface 52 (third surface) of the downstream side fixing member 5 (second fixing member).

According to this configuration, the protective layer 8 can avoid the outer peripheral edge portion of the inflow side surface 52 (third surface) continuous to the joint interface 51 from being directly exposed to high-temperature and high-pressure water vapor. Therefore, it is possible to suppress deterioration of the downstream side fixing member 5 (second fixing member) such that the joint interface 51 of the downstream side fixing member 5 (second fixing member) peels off from the housing 3.

### Second Embodiment

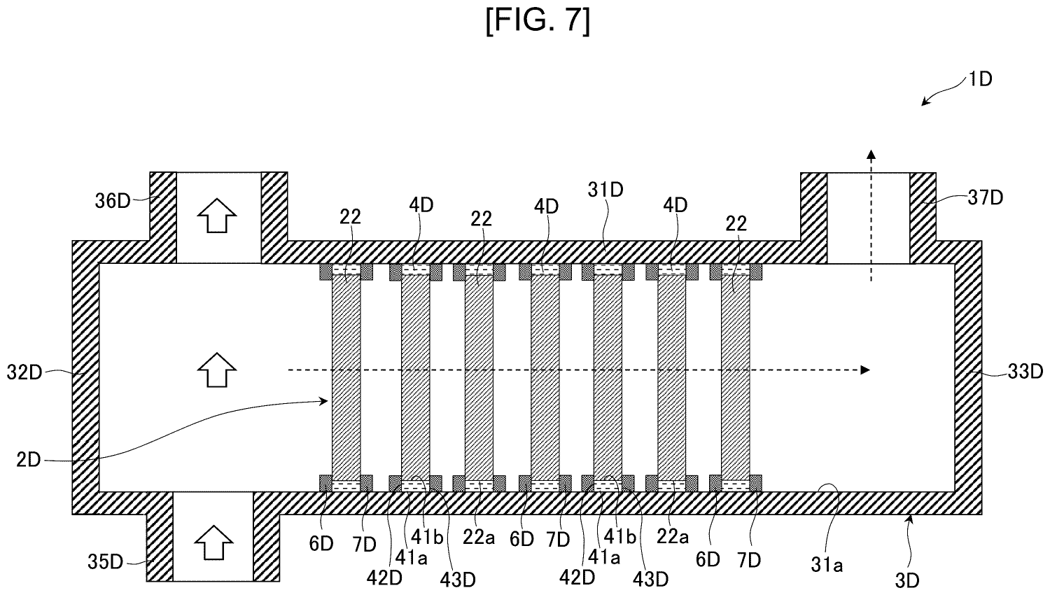

Next, the gas separation module according to the second embodiment of the present invention will be described with reference to FIG. 7. FIG. 7 is a cross-sectional view schematically illustrating the configuration and the structure of the gas separation module according to the second embodiment. Note that in FIG. 7, those having the same reference signs as those illustrated in FIGS. 1 to 6 are similar parts, and therefore detailed description thereof will be omitted.

A main difference between a gas separation module 1D according to the second embodiment illustrated in FIG. 7 and the gas separation module 1 according to the first embodiment (see FIG. 1) is that the configuration of a filter member 2D is different, and accordingly, the configuration of a housing 3D, the configuration of a fixing member 4D, and the configurations of protective layers 6D and 7D are different.

Specifically, the filter member 2D is not formed of a hollow fiber membrane but is a filter member of film type. In the filter member 2D, a large number of membranes 22 of film type are arranged in series in the axial direction of a tubular body portion 31D. Similarly to the filter member 2 configured by the hollow fiber membranes 21 of the first embodiment, the filter member 2D (membrane 22 of film type) has a characteristic of selectively transmitting water vapor and hydrogen gas, and not transmitting gas having a molecular size (dynamic molecular diameter) larger than that of water vapor and hydrogen gas.

The housing 3D includes the tubular body portion 31D forming a housing space for housing the large number of the membranes 22 of film type configuring the filter member 2D, a first bottom portion 32D closing one side end portion (left end portion in FIG. 7) of the tubular body portion 31D, and a second bottom portion 33D closing the other side end portion (right side end portion in FIG. 7) of the tubular body portion 31D. A part on the first bottom portion 32D side in the tubular body portion 31D is provided with an inflow port 35D through which the mixture gas flows into. The inflow port 35D is a part positioned most upstream of the gas separation module 1D. A part on a facing side of the inflow port 35D on the first bottom portion 32D of the tubular body portion 31D is provided an outflow port 36D for guiding, to the outside of the housing 3D, a gas not permeating the filter member 2D of the mixture gas. A part on the second bottom portion 33D side of the tubular body portion 31D is provided with a downstream side opening portion 37D, which is an outflow port for guiding, to the outside of the housing 3D, a gas permeating the filter member 2D. That is, the housing 3D is configured such that the gas permeating the filter member 2D flows along the axial direction of the tubular body portion 31D, and the mixture gas having not permeated the filter member 2D flows through on one side end portion on the first bottom portion 32D side of the tubular body portion 31D.

Each of the large number of the membranes 22 of film type configuring the filter member 2D are fixed to the housing 3D by the fixing member 4D. The fixing member 4D is formed of resin similar to that in the case of the first embodiment as a main component. The fixing member 4D is formed by solidifying the same resin as that in the first embodiment between an outer peripheral surface 22a of each membrane 22 and the inner peripheral surface 31a of the tubular body portion 31D. Due to this, a joint interface 41a, which is an outer peripheral surface of the fixing member 4D, is joined to the inner peripheral surface 31a of the housing 3 (tubular body portion 31) and a joint interface 41b, which is an inner peripheral surface of the fixing member 4D, is joined to the outer peripheral surface 22a of the membrane 22, whereby the fixing member 4D fixes (fixing function) the filter member 2D (each membrane 22 of filter type) to the housing 3, and seals (sealing function) a gap between the filter member 2D (each membrane 22) and the housing 3D (tubular body portion 31D). The fixing member 4D has, as surfaces of the fixing member 4D, an annular inflow side surface 42D as a first surface facing the first bottom portion 32D side (inflow port 35D side) of the housing 3D, and an annular outflow side surface 43D as a second surface positioned on the opposite side of the inflow side surface 42D and facing the second bottom portion 33D side (downstream side opening portion 37D) of the housing 3D.

Of the surfaces of the fixing member 4D, the inflow side surface 42D positioned on the upstream side in the flow direction of the gas permeating the membrane 22 is covered with the protective layer 6D. The protective layer 6D covers the entire surface of the inflow side surface 42D having an annular shape continuous to the joint interface 41a of the fixing member 4D joined to the inner peripheral surface 31a of the housing 3D and the joint interface 41b of the fixing member 4D joined to the outer peripheral surface 22a of the filter member 2D.

Of the surfaces of the fixing member 4D, the outflow side surface 43D positioned on the downstream side in the flow direction of the gas permeating the membrane 22 is covered with the protective layer 7D. The protective layer 7D covers the entire surface of the outflow side surface 43D having an annular shape continuous to the joint interface 41a of the fixing member 4D joined to the inner peripheral surface 31a of the housing 3D and the joint interface 41b of the fixing member 4D joined to the outer peripheral surface 22a of the filter member 2D.

Similarly to the case of the first embodiment, the protective layer 6D and the protective layer 7D are formed of an inorganic material having a characteristic of shielding water vapor and having heat resistance higher than that of the fixing member 4D. The inorganic materials of the protective layer 6D and the protective layer 7D are the same materials as those of the protective layer 6 of the first embodiment.

Similarly to the case of the first embodiment, the thermal expansion coefficients among the three members of the fixing member 4D, the housing 3D, and the protective layers 6D and 7D are preferably as close as possible to one another. The thermal expansion coefficient among the three members of the fixing member 4D, the housing 3D, and the protective layers 6D and 7D is the same relationship of the expression (1) as that in the case of the first embodiment, for example.

Next, actions and effects of the gas separation module according to the second embodiment will be described with reference to FIG. 7. Also here, a case where a mixture gas containing high-temperature and high-pressure water vapor is supplied will be described as an example.

In the present embodiment, the high-temperature and high-pressure mixture gas (see white arrow) supplied into the housing 3D via the inflow port 35D of the gas separation module 1D is first introduced into the membrane 22 of the filter member 2D positioned at the foremost stage on the upstream side. The water vapor and the hydrogen gas contained in the mixture gas are selectively permeated by the plurality of membranes 22 constituting the filter member 2D, and then flow out to the outside of the housing 3D via the downstream side opening portion 37D (see broken line arrow). On the other hand, of the mixture gas, water vapor and hydrogen gas having not been permeated the filter member 2D, and a gas having a molecular size (dynamic molecular diameter) larger than that of the water vapor and hydrogen gas are guided to the outflow port 36D (see white arrow). In this manner, in the gas separation module 1D, a specific gas (water vapor and hydrogen gas) of the mixture gas permeates the membrane 22 and flows to the second bottom portion 33D side, and the remaining gas is prevented from flowing to the second bottom portion 33D side by the membrane 22 and flows to the outflow port 36D, thereby performing gas separation.

Thus, in the present embodiment, the entire surfaces of the inflow side surface 42D and the outflow side surface 43D having an annular shape in the fixing member 4D that fixes, to the housing 3D, the respective membranes 22 of the filter member 2D that high-temperature and high-pressure water vapor permeates are covered with the protective layer 6D and the protective layer 7D excellent in shielding property of water vapor and heat resistance. Due to this, the entirety of the inflow side surface 42D and the outflow side surface 43D of the fixing member 4D can be avoided from being directly exposed to high-temperature and high-pressure water vapor, and therefore deterioration due to high-temperature water vapor of the fixing member 4D mainly made of a resin material is suppressed, and durability of the fixing member 4D under high-temperature water vapor can be enhanced. Hence, the fixing function of the fixing member 4D for fixing the filter member 2D to the tubular body portion 31D and the sealing function of the fixing member 4D for sealing the gap between the filter member 2D and the tubular body portion 31D can be prevented from being damaged by deterioration of the fixing member 4D, and therefore the gas separation performance of the gas separation module 1D under a severe environment can be maintained.

In the present embodiment, the entire surface of the inflow side surface 42D having an annular shape of the fixing member 4D is covered with the protective layer 6D. This can avoid the inflow side surface 42D continuous to the joint interface 41a and the joint interface 41b of the fixing member 4D from being directly exposed to high-temperature and high-pressure water vapor. For this reason, the deterioration form due to the high-temperature water vapor of the fixing member 4D in which the joint interface 41a and the joint interface 41b of the fixing member 4D are peeled off from the inner peripheral surface 31a of the housing 3D and the outer peripheral surface 22a of the membrane 22 is suppressed, and therefore durability of the fixing member 4D under high-temperature water vapor can be enhanced.

In the present embodiment, the entire surface of the outflow side surface 43D having an annular shape of the fixing member 4D is covered with the protective layer 7D. This can avoid the outflow side surface 43D continuous to the joint interface 41a and the joint interface 41b of the fixing member 4D from being directly exposed to high-temperature and high-pressure water vapor. For this reason, the deterioration form due to the high-temperature water vapor of the fixing member 4D in which the joint interface 41a and the joint interface 41b of the fixing member 4D are peeled off from the inner peripheral surface 31a of the housing 3D and the outer peripheral surface 22a of the membrane 22 is suppressed, and therefore durability of the fixing member 4D under high-temperature water vapor can be enhanced.

According to the gas separation module 1D according to the third embodiment described above, similarly to the first embodiment, at least a part of the inflow side surface 42D (first surface) of the fixing member 4D is covered with the protective layer 6D excellent in shielding property of water vapor and heat resistance, whereby it is possible to reduce the region of the inflow side surface 42D (first surface) directly exposed to high-temperature water vapor at the time of gas separation of the mixture gas containing the high-temperature water vapor. Due to this, deterioration of the fixing member 4D due to high-temperature water vapor is suppressed, and therefore durability of the fixing member 4D under high-temperature water vapor can be enhanced.

### Other Embodiments

Note that the present invention is not limited to the above-described first and second embodiments and the modification thereof but includes various modifications. The above-described embodiments have been described in detail in order to explain the present invention in an easy-to-understand manner, and are not necessarily limited to those including all the configurations described. The present invention can be appropriately combined and improved without departing from the technical idea of the invention. It is possible to replace a part of the configuration of a certain embodiment with the configuration of another embodiment, and it is also possible to add the configuration of another embodiment to the configuration of a certain embodiment. Another configuration can also be added to, deleted from, or replaced with a part of the configuration of each embodiment.

For example, in the second modification of the first embodiment described above, an example (see FIG. 5) in which only the annular outer peripheral edge portion continuous to the joint interface 41 on both surfaces of the inflow side surface 42 and the outflow side surface 43 of the upstream side fixing member 4 is covered with the protective layer 6A and the protective layer 7 has been described. However, as in the first embodiment, a configuration of covering the entire surface of the inflow side surface 42 of the upstream side fixing member 4 with a protective layer is possible. A configuration of covering the entire surface of the outflow side surface 43 of the upstream side fixing member 4 with a protective layer is also possible.

In the third modification of the first embodiment described above, an example (see FIG. 6) in which only the annular outer peripheral edge continuous to the joint interface 51 on the inflow side surface 52 of the downstream side fixing member 5 is covered with the protective layer 8 has been described. However, a configuration of covering the entire surface of the inflow side surface 52 of the downstream side fixing member 5 with a protective layer is also possible. Similarly to the second modification of the first embodiment, a configuration of covering the entire surfaces of both surfaces of the inflow side surface 42 and the outflow side surface 43 of the upstream side fixing member 4 with a protective layer is possible.

In the above-described first and second embodiments and the modification thereof, an example of the configuration in which the filter members 2 and 2D separate water vapor and hydrogen from the mixture gas has been described. However, the filter member may be able to separate at least one type of specific gas from the mixture gas.

In the above-described first embodiment and the modifications thereof, an example in which the gas separation modules 1, 1A, 1B, and 1C are supplied with one fluid (mixture gas) to perform gas separation has been described. However, a configuration in which the gas separation modules 1, 1A, 1B, and 1C are supplied with two fluids to perform gas separation is also possible. Specifically, in the gas separation modules 1, 1A, 1B, and 1C, for example, a dehumidification target fluid as a mixture gas is supplied via the inflow port 35 of the housing 3, and a humidification target fluid is supplied via one of the upstream side opening portion 37 and the downstream side opening portion 38 of the housing 3. Due to this, the dehumidification target fluid passes through the hollow portion of the filter member 2 and flows out via the outflow port 36 of the housing 3, and moisture of the dehumidification target fluid permeates the filter member 2 and joins the humidification target fluid. The humidification target fluid flows into the housing 3 from one of the upstream side opening portion 37 and the downstream side opening portion 38, and flows out via the other of the upstream side opening portion 37 and the downstream side opening portion 38 together with the moisture having permeated the filter member 2.

### REFERENCE SIGNS LIST

1, 1A, 1B, 1C, 1D gas separation module
2, 2D filter member
3, 3D housing
4 upstream side fixing member (fixing member, first fixing member)
4D fixing member
5 downstream side fixing member (fixing member, second fixing member)
6, 6A, 6D protective layer
7, 7D protective layer
8 protective layer
21 hollow fiber membrane
35, 35D inflow port
36, 36D outflow port
41 joint interface
41a joint interface
41b joint interface
42, 42D inflow side surface (first surface)
43, 43D outflow side surface (second surface)
51 joint interface
52 inflow side surface (third surface)
53 outflow side surface (fourth surface)

1. A gas separation module, comprising:
a filter member that separates a specific gas from a mixture gas;
a housing that has an inflow port through which the mixture gas flows into and houses the filter member; and
a fixing member that fixes the filter member to the housing and seals a gap between the filter member and the housing,
wherein at least a part of a first surface, which is a surface facing the inflow port side of the housing, of surfaces of the fixing member is covered with a protective layer, and
the protective layer is formed of an inorganic material having a characteristic of shielding water vapor and having a characteristic of being superior in heat resistance to the fixing member.

2. The gas separation module according to claim 1, wherein
the protective layer is made of glass having a softening point of 300° C. or higher and 360° C. or lower.

3. The gas separation module according to claim 1, wherein
a thermal expansion coefficient of the fixing member is a value between a thermal expansion coefficient of the housing and a thermal expansion coefficient of the protective layer, or a same value as a thermal expansion coefficient of any one of the housing and the protective layer.

4. The gas separation module according to claim 1, wherein
the protective layer covers an entire surface of the first surface.

5. The gas separation module according to claim 1, wherein
the protective layer covers an annular outer peripheral edge portion of the first surface, the annular outer peripheral edge portion being a region continuous to a joint interface of the fixing member joined to the housing.

6. The gas separation module according to claim 1, wherein
the protective layer covers at least a part of a second surface, which is a surface positioned on an opposite side of the first surface, of surfaces of the fixing member.

7. The gas separation module according to claim 6, wherein
the protective layer covers an annular outer peripheral edge portion of the second surface, the annular outer peripheral edge portion being a region continuous to a joint interface of the fixing member joined to the housing.

8. The gas separation module according to claim 1, wherein
the filter member is configured by bundling a plurality of hollow fiber membranes,
the filter member has an end portion on one side and an end portion on an other side in an extending direction of the plurality of hollow fiber membranes fixed to the housing by the fixing member,
the housing has the inflow port on the one side in the extending direction,
the fixing member has a first fixing member that fixes the end portion on the one side of the plurality of hollow fiber membranes to the housing and a second fixing member that fixes the end portion on the other side of the plurality of hollow fiber membranes to the housing,
at least a part of a first surface, which is a surface facing the inflow port side of the housing, of surfaces of the first fixing member is covered with the protective layer, and,
at least a part of a third surface which is a surface facing the inflow port side of the housing, of surfaces of the second fixing member is covered with the protective layer.

9. The gas separation module according to claim 8, wherein
the protective layer covers an annular outer peripheral edge portion of the third surface of the second fixing member, the annular outer peripheral edge portion being a region continuous to a joint interface of the second fixing member joined to the housing.
